(19) United States
(12) Patent Application Publication
(10) Pub. No.: US 2009/0027207 A1
(43) Pub. Date: Jan. 29, 2009

(54) Method and system for securing movement of an object

(76) Inventors: Jerry Shelton, Boise, ID (US); Paul M. Dunn, Boise, ID (US); Michael J. Shelton, Boise, ID (US); Curtis Gold, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/881,751

(22) Filed: Jul. 27, 2007

(51) Int. Cl. G08B 13/14

(52) U.S. Cl. 340/572.4

(57) ABSTRACT

A method for securing movement of an object through a secure area includes providing a first electronic tag for the object, the first tag having a first memory and a second electronic tag, having a second memory, for an individual. The first memory stores an attribute of object and information of an individual permitted to move the object. The second memory stores an identifying attribute of an individual and a type of biometric information of the individual. Identifying attributes of the individual stored in the second memory are compared with information of permitted individuals stored in the first memory. Biometric information is obtained from the individual and compared with biometric information stored in the second memory to validate the identity of the individual.

### BACKGROUND

Secure storage and transfer of items is important for sensitive, expensive, or hard-to-replace equipment. In relatively unsecure areas, lack of such security measures may result in equipment loss. Systems exist that track the movement of devices. Systems also exist that track individuals that move equipment. Some of these systems also use a centralized database to track the association of objects with individuals moving the objects.

Systems that track objects and their association with individuals moving the objects, often rely either on manual validation of the identity of the personnel moving objects and whether they have requisite authority to move objects or on electronic tracking of the objects only. Such manual monitoring of movement of objects results in increased overhead to maintain accurate equipment locations, lost equipment and potential operations inefficiencies.

### BRIEF DESCRIPTION OF THE DRAWINGS

The drawings referenced herein form a part of the specification. Features shown in the drawings are meant as illustrative of exemplary embodiments of the invention.

FIG. 1 is a schematic diagram showing a system for tracking and associating an object with an individual according to an exemplary embodiment of the invention.

FIGS. 2A and 2B are schematic diagrams of electronic tags assigned to an object and an individual according to an exemplary embodiment of the invention.

FIG. 3 illustrates a Memory Spot chip, for use in an electronic tag of FIGS. 2A and 2B according to an exemplary embodiment of the invention.

FIG. 4 illustrates an exemplary process flow of a method of securing movement of an object according to an exemplary embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined by the appended claims.

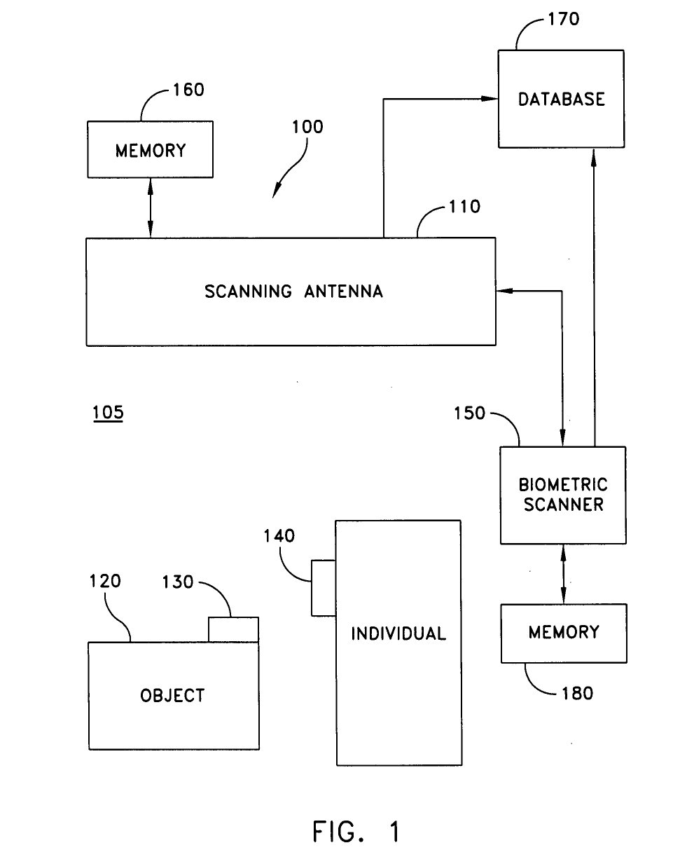

FIG. 1 illustrates a system 100 for monitoring the movement of an object 120 through a secure area 105 and for associating an individual with object 120 according to an exemplary embodiment of the present invention. According to an embodiment of the present invention, a scanning antenna 110 is configured to scan secure area 105 for the presence of electronic tags 130 and 140. In an alternative embodiment, two distinct scanning antennas may be employed to scan for electronic tags 130 and 140 respectively. Scanning antenna 110 is electronically coupled to a biometric scanner 150 and a memory 160. Biometric scanner 150 is configured to receive at least one type of biometric information from an individual. Biometric information may include fingerprints, retina scan, voice print, ear print or heart sounds or any combination thereof. In an exemplary embodiment of the present invention, system 100 includes a database 100. Database 100 may either be locally situated or may be located at a remote location. Database 100 is accessible to scanning antenna 110 and biometric scanner 150.

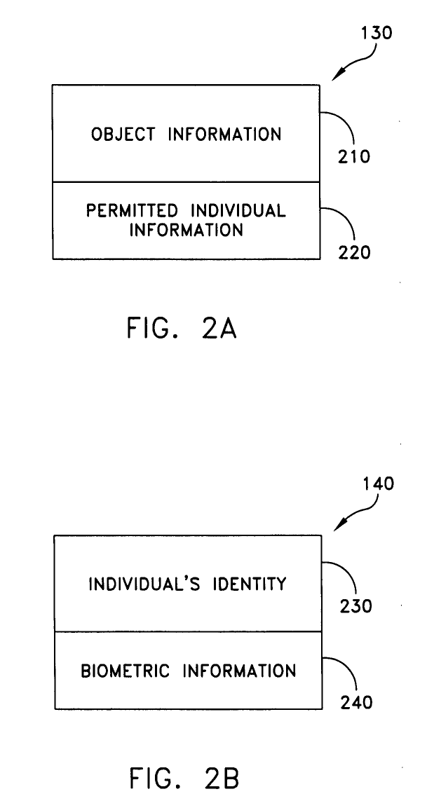

FIGS. 2A and 2B illustrate a schematic representation of electronic tags 130 and 140. Electronic tag 130 is assigned to object 120 (of FIG. 1). Object 120 may be, by way of non-limiting examples only, biological samples, toxic microbes, secret documents, electronic equipment such as a printer, a hard drive, and a laptop computer. Electronic tag 130 may store information 210, regarding at least one attribute of the object, and information 220, regarding at least one individual who is permitted to move object 120. Electronic tag 140 may store information 230, which may be an identifying attribute of the individual. Such identifying attribute may include, by way of example only, name of the individual, some identity number such as social security number or other assigned numbers, and security clearance code. Electronic tag 140 may further store information 240, which includes at least one type of biometric information unique to the individual whose identity is stored in electronic tag 140. Electronic tags 130 and 140 may also store additional information and is not limited to the type of information illustrated in the illustrative drawings.

According to an embodiment of the present invention, electronic tags 130 and 140 may be in the form of Radio Frequency Identification Device (RFID) tags. Such RFID tags may be active or passive. Active RFID tags are self-powered, e.g. battery-powered, and can be detected at a distance of about 10-20 feet. Passive RIFD tags, on the other hand, require close proximity to be read by an antenna. RFID tags include transponders which are capable of transmitting data upon receiving a designated incoming signal.

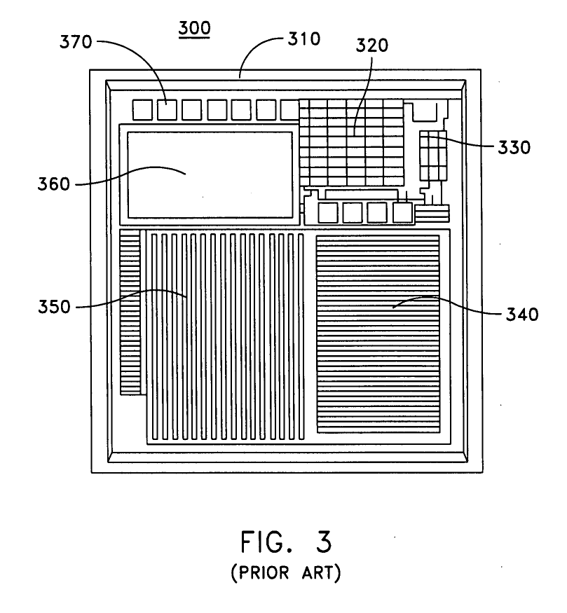

FIG. 3 illustrates an exemplary RFID tag, also known as “Memory Spot.” Memory Spot 300 is a memory device based on Complementary Metal Oxide Semiconductor (CMOS), which is a widely used low-power integrated circuit design. An exemplary embodiment of Memory Spot 300 has a size of two (2) millimeter (mm) to four (4) millimeter (mm) square, or smaller. Memory Spot 300 has a loop antenna 310 for receiving and transmitting data signals wirelessly. A capacitor array 310 provides power to Memory Spot 300. Memory Spot 300 further includes a modem 330, a memory 340, a memory driver 350, a processor 360 and test pads 370. Memory 340 may store the information identified as 210, 220, 230 and 240 of FIGS. 2A and 2B.

Referring back to FIG. 1, memory 160 contains a computer code to retrieve information from electronic tags 130 and 140. Memory 180 also contains a computer code to compare biometric information received by biometric scanner 150 from the individual with the biometric information 240 stored in electronic tag 140.

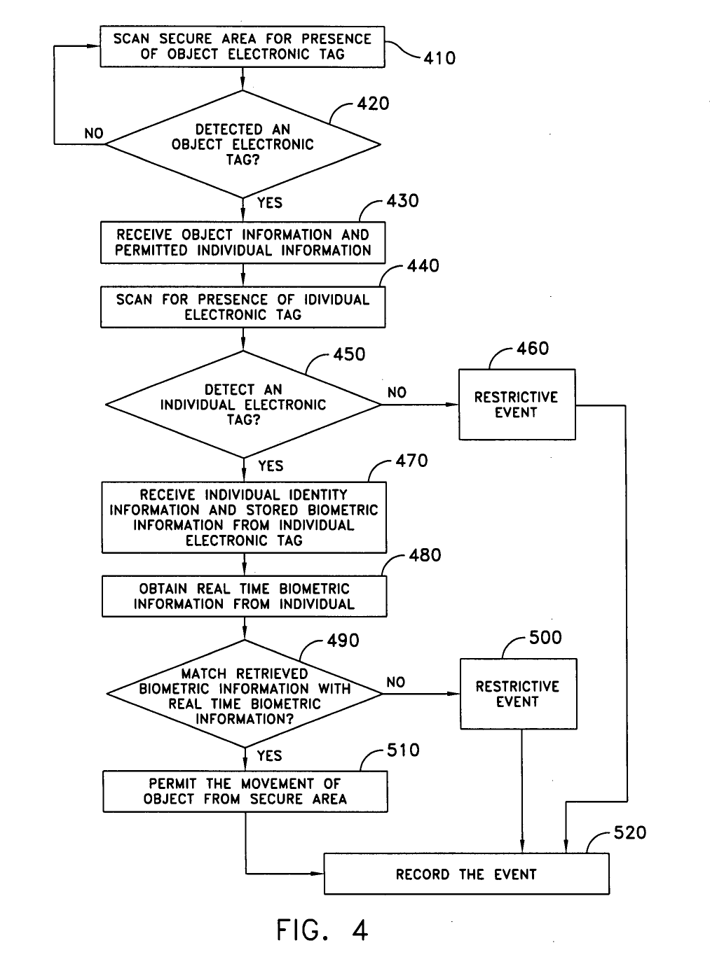

FIG. 4 illustrates an exemplary process flow for securing movement of object 120 using the system 100. Secure area 105 is scanned by scanning antenna 110 for the presence of electronic tag 130, as at block 410. If electronic tag 130 is detected in secure area 105 (blocks 420, 430), scanning antenna 110 activates the transponder of electronic tag 130 to enable data transfer between electronic tag 130 and scanning antenna 110 and receives information 210 regarding object 120 and information 220 regarding an individual permitted to move object 120. Scanning antenna 110 then scans secure area 105 for the presence of electronic tag 140 assigned to an individual permitted to move object 120, as at block 450. In one embodiment of the present invention, if no electronic tag 140 assigned to an individual permitted to move object 120 is detected, a restrictive event occurs. An example of such a restrictive event may be triggering of an alarm. Another example may be that the object and the individual may be confined to the secure area by blocking egress from the secure area. In yet another embodiment, the restrictive event may simply be recording the event. In one embodiment of the present invention, the restrictive event may be recorded in database 170 for future retrieval (block 520). Such a database may be either be local or be at a remote location.

At block 470, scanning antenna 110 activates the transponder of electronic tag 140 to enable data transfer between electronic tag 140 and scanning antenna 110 and receives information 230 regarding the identity of the individual and information 240. Information 240 includes at least one type of biometric information unique to the individual to whom electronic tag 140 is assigned. System 100 then directs the individual to provide at least one predetermined type of biometric information to biometric scanner 150.

The biometric information obtained from the individual is compared with information 240, which includes at least one type of biometric information unique to the individual to whom electronic tag 140 is assigned (block 490). If the received real time biometric information matches with stored information 240, object 120 and the individual are permitted to leave secure area 105, as at block 510. In an exemplary embodiment of the present invention, the movement of object 120 through secure area 105 is recorded in database 170 for later retrieval. In one embodiment of the present invention, if the received real time biometric information does not match with stored information 240, a restrictive event occurs. An example of such a restrictive event may be triggering of an alarm. Another example may be that the object and the individual may be confined to the secure area by blocking egress from the secure area. In yet another embodiment, the restrictive event may simply be recording the event. In one embodiment of the present invention, if the alarm is triggered, the restrictive event may be recorded in a database for future retrieval (block 520).

In one embodiment of the present invention, system 100 may be in form of a network of transfer points, each of which may be connected to database 170 which would store all the events including the authorized and unauthorized movements of object 10. Database 170 may be at a remote location or it may be locally situated. In another embodiment of the present invention, system 100 may be in the form of non-networked transfer points, each of which is a stand-alone system which scans for presence of object 110, through the presence of electronic tag 130, and identifies and validates the identity of the individual moving object 110 through secure area 105. Data relating to authorized and unauthorized movement of object 110 may be locally recorded for later retrieval. System 100 thus may track object 110, may track who moves object 110, may validate the identity of the individual transferring object 110, may restrict the movement of object 110, and may provide immediate notification in the event of unauthorized movement of object 100.

It is noted that, although specific embodiments have been illustrated and described herein, it will be appreciated by those of ordinary skill in the art that any arrangement calculated to achieve the same purpose may be substituted for the specific embodiments shown. For example, whereas some embodiments of the invention have been described in relation to a series of check points which are networked to a single remote database, other embodiments of the invention can include stand-alone check points without any central database. This application is thus intended to cover adaptations or variations of the disclosed embodiments of the present invention. Therefore, it is intended that this invention be limited only by the claims and equivalents thereof.

We claim:

1. A method for securing movement of an object through a secure area, said method comprising the steps of:
providing a first electronic tag for the object, said first electronic tag comprising a first memory;
storing in said first memory of said first electronic tag at least one attribute of the object and information of at least one individual permitted to move the object;
providing a second electronic tag for an individual, said second electronic tag comprising a second memory, said second memory storing at least one identifying attribute of said individual and at least one type of biometric information of said individual;
scanning the secure area for presence of said first electronic tag;
if said first tag is detected in the secure area, then retrieving information regarding at least one permitted individual from said first electronic tag;
scanning the secure area for presence of said second electronic tag;
if said second tag is detected, then comparing said at least one identifying attribute of said individual stored in said second memory of said second tag assigned to the individual with the information of permitted individual stored in said first memory of said first tag;
obtaining biometric information from an individual present in said secure area, if said second electronic tag provided to said at least one permitted individual is detected in said first area;
comparing said obtained biometric information from the individual with said biometric information stored in said second memory of said second electronic tag to verify that the individual carrying said second electronic tag is the individual to whom said second electronic tag was provided.

2. The method of claim 1, further comprising the step of triggering a restrictive event if said second electronic tag provided to said at least one individual is not present in the secure area.

3. The method of claim 2, wherein said step of triggering a restrictive event comprises triggering an alarm.

4. The method of claim 2, wherein said step of triggering a restrictive event comprises blocking egress from the secure area.

5. The method of claim 1, further comprising the step of triggering a restrictive event if said obtained biometric information from the individual does not match with said biometric information stored in said second memory of said second electronic tag.

6. The method of claim 5, wherein said step of triggering a restrictive event comprises triggering an alarm.

7. The method of claim 5, wherein said step of triggering a restrictive event comprises blocking egress from the secure area.

8. The method of claim 1, further comprising the step of recording each instance when said first electronic tag is detected in the secure area.

9. The method of claim 1, further comprising the step of recording each instance when said second electronic tag is detected in the secure area.

10. The method of claim 1, further comprising the step of recording each instance when said obtained biometric information from the individual matches with said biometric information stored in said second memory of said second electronic tag.

11. The method of claim 1, further comprising the step of recording each instance when said obtained biometric information from the individual does not match with said biometric information stored in said second memory of said second electronic tag.

12. The method of claim 1, wherein said at least one biometric information is selected from one of the group consisting of fingerprint, retinal scan, voice print and heart sounds.

13. A system for securing movement of an object through a secure area, said method comprising:
a first electronic tag physically coupled to the object, said first electronic tag having a first memory, wherein said first memory stores at least one attribute of the object and information of at least one individual permitted to move the object;
a second electronic tag assigned to an individual, said second electronic tag having a second memory, wherein said second memory storing at least one identifying attribute of the individual and at least one type of biometric information of the individual;
a first scanner configured to detect the presence of said first electronic tag in the secure area, said first scanner having access to a third memory, wherein said third memory contains a first code for retrieving information regarding at least one permitted individual from said first electronic tag;
a second scanner configured to detect the presence of said second electronic tag in the secure area, said second scanner having access to a fourth memory, wherein said fourth memory contains a second code for retrieving information regarding the identifying attribute of the individual from said second electronic tag and a third code for comparing the information retrieved from said first electronic tag with the information retrieved from said second electronic tag; and
a biometric information scanner configured to receive at least one type of biometric information from the individual, said scanner having access to a fifth memory, wherein said fifth memory containing a fifth code for retrieving at least one type of biometric information stored in said second electronic tag and a sixth code for comparing the at least one type of biometric information received from the individual with the at least one type of biometric information stored in said second electronic tag, thereby verifying the identity of the individual carrying the second electronic tag.

14. The system of claim 13, further comprising a security alarm, wherein said security alarm is configured to trigger when no said second electronic tag is detected in the secure area.

15. The system of claim 13, further comprising a security alarm, wherein said security alarm is configured to trigger when said obtained biometric information from the individual does not match with said at least one type of biometric information of the individual stored in said second electronic tag.

16. The system of claim 13, wherein said at least one biometric information stored in said second electronic tag is selected from the group consisting of fingerprint, retinal scan, voice print and heart sounds.

17. The system of claim 13, further comprising a database wherein an event is recorded, the event selected from the group consisting of: detecting the presence of said first electronic tag in the secure area, detecting the presence of said second electronic tag in the secure area, failing to detect the presence of said second electronic tag in the secure area, successfully matching said obtained biometric information from said at least one individual with stored biometric information in said second memory of said second electronic tag, and failing to match said obtained biometric information from said at least one individual with stored biometric information in said second memory of said second electronic tag.
